(19) United States
(12) Patent Application Publication
(10) Pub. No.: US 2025/0058886 A1
(43) Pub. Date: Feb. 20, 2025

(54) CENTRIFUGAL COMPRESSOR-TURBINE BACK-TO-BACK

(71) Applicant: ZeroAvia Ltd, Cirencester (GB)

(72) Inventors: Asif Mohammad SADIK, Gloucestershire (GB); Jonathan Leopold Nutzati FONTAINE, Hollister, CA (US)

(21) Appl. No.: 18/806,494

(22) Filed: Aug. 15, 2024

Related U.S. Application Data
(60) Provisional application No. 63/532,871, filed on Aug. 15, 2023.

(51) Int. Cl. B64D 27/31; F04D 17/10; H01M 8/04014; H01M 8/0662; H01M 8/10

(52) U.S. Cl. CPC B64D 27/31; F04D 17/10; H01M 8/04014; H01M 8/0662; H01M 2008/1095; H01M 2250/20

(57) ABSTRACT

An integrated hydrogen FC electric engine includes a centrifugal compressor and a turbine rotatably mounted, back-to-back on a common shaft; and one or more FCs arranged around an outside of the rotatably mounted centrifugal compressor and the rotatably mounted turbine. The integrated hydrogen FC electric engine is compact enough to fit into the nacelle of an aircraft.

### CROSS REFERENCE TO RELATED APPLICATION

This application claims benefit to U.S. Provisional Patent Application Ser. No. 63/532,871, filed Aug. 15, 2023, the contents of which are incorporated herein by reference in its entirety.

### TECHNICAL FIELD

The present disclosure relates to hydrogen fuel cell (FC) electric engine systems for use with vehicles such as aircraft and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

Exhaust emissions from transport vehicles are a significant contributor to climate change. Conventional fossil-fuel-powered aircraft engines release CO₂ emissions. Also, fossil-fuel-powered aircraft emissions include non-CO₂ effects due to nitrogen oxide (NOx), vapor trails, and cloud formation triggered by the altitude at which aircraft operate. These non-CO₂ effects are believed to contribute twice as much to global warming as aircraft CO₂ and are estimated to be responsible for two-thirds of aviation's climate impact. Additionally, the high-speed exhaust gasses of conventional fossil-fuel-powered aircraft engines contribute significantly to the extremely large noise footprint of commercial and military aircraft, particularly in densely populated areas.

Rechargeable battery-powered terrestrial vehicles, i.e., “EVs”, are slowly replacing conventional fossil-fuel-powered terrestrial vehicles. However, the weight of batteries and limited energy storage of batteries makes rechargeable battery-powered aircraft generally impractical.

Hydrogen FCs offer an attractive alternative to fossil-fuel-burning engines. Hydrogen FC tanks may be quickly filled and store significant energy, and other than the relatively small amount of unreacted hydrogen gas, the reaction output exhausted from hydrogen FCs comprises essentially only water.

In our prior US Published Application No. US 2021/0151783, we describe an integrated hydrogen FC-powered electric engine system that can be utilized, for example, in a turboprop or turbofan system, to provide a streamlined, light weight, power dense and efficient system. Referring to FIG. 1, the integrated hydrogen-electric engine system 1 includes an elongated shaft 10 that defines a longitudinal axis “L” and extends through the entire powertrain of integrated hydrogen-electric engine system 1 to function as a common shaft for the various components of the powertrain. Elongated shaft 10 supports propulsor 14 (e.g., a fan or propeller), a multi-stage air compressor system 12, 12a, 12b, a fuel pump 22 in fluid communication with a fuel source (e.g., liquid hydrogen—LH₂), a heat exchanger 24 in fluid communication with air compressor system 12, 12a, 12b, a FC stack 26 in fluid communication with heat exchanger 24, and a motor assembly 30 disposed in electrical communication with FC stack 26.

Air compressor system 12, 12a, 12b of integrated hydrogen-electric engine system 1 includes an air inlet portion 12a at a distal end thereof and a compressor portion 12b that is disposed proximally of air inlet portion 12a for uninterrupted, axial delivery of air flow in the proximal direction. Compressor portion 12b supports a plurality of longitudinally spaced-apart rotatable compressor wheels 16 (e.g., multi-stage) that rotate in response to rotation of elongated shaft 10 for compressing air received through air inlet portion 12a for pushing the compressed air to a FC stack 26 for conversion to electrical energy. As can be appreciated, the number of compressor wheels/stages 16 and/or diameter, longitudinal spacing, and/or configuration thereof can be modified as desired to change the amount of air supply, and the higher the power, the bigger the propulsor 14. These compressor wheels 16 can be implemented as axial or centrifugal compressor stages. Further, the compressor can have one or more bypass valves and/or wastegates 17 to regulate the pressure and flow of the air that enters the downstream FC, as well as to manage the cold air supply to any auxiliary heat exchangers in the system.

Compressor 12b optionally can be mechanically coupled to elongated shaft 10 via a gearbox 18 to change (increase and/or decrease) compressor turbine rotations per minute (RPM) and to change air flow to FC stack 26. For instance, gearbox 18 can be configured to enable the air flow, or portions thereof, to be exhausted for controlling a rate of air flow through the FC stack 26, and thus, the output power.

Integrated hydrogen-electric engine system 1 further includes a gas management system such as a heat exchanger 24 disposed concentrically about elongated shaft 10 and configured to control thermal and/or humidity characteristics of the compressed air from air compressor system 12 for conditioning the compressed air before entering FC stack 26. Integrated hydrogen-electric engine system 1 further also includes a fuel source 20 of cryogenic fuel (e.g., liquid hydrogen—LH₂, or cold hydrogen gas) that is operatively coupled to heat exchanger 24 via a pump 22 configured to pump the fuel from fuel source 20 to heat exchanger 24 for conditioning. In particular, the LH₂ fuel, while in the heat exchanger 24, becomes gasified because of heating (e.g., LH₂ converts to hydrogen gas—H₂) taking heat out of the system. The hydrogen gas is then heated in the heat exchanger 24 to a working temperature of the FC 26 which also takes heat out of the compressed air, which results in a control of flow through the heat exchanger 24. In one embodiment, a heater 39 can be coupled to or included with heat exchanger 24 to increase heat as necessary, for instance, when running under a low power regime. Integrated hydrogen-electric engine system also may include one or more external radiators 19 for facilitating air flow and adding, for instance additional cooling. Additionally, and/or alternatively, motor assembly 30 can be coupled to heat exchanger 24 for looping in the cooling/heating loops from motor assembly 30 as necessary. Such heating/cooling control can be managed, for instance, via controller 200 of integrated hydrogen-electric engine system 1. In one embodiment, fuel source 20 can be disposed in fluid communication with motor assembly 30 or any other suitable component to facilitate cooling of such components. Motor assembly 30 can include any number of FC modules configured to march the power of the motors and the inverters 28, 29.

Pump 22 can be coaxially supported on elongated shaft 10 for actuation thereof in response to rotation of elongated shaft 10. Heat exchanger 24 is configured to cool the compressed air received from air compressor system 12, 12a, 12b with the assistance of the pumped liquid hydrogen.

While existing hydrogen FC-powered electric engine system, such as those disclosed in our US Published Application 2021/0151783, and as illustrated in FIG. 1, discussed above, advantageously may be mounted in the fuselage of an aircraft or a large nacelle mounted to an aircraft, existing hydrogen FCs can be too large and awkwardly shaped for packaging in conventional aircraft nacelles. In particular, the long shaft employed with existing hydrogen FC-powered engine systems as above described is too long to fit within conventional aircraft nacelles, which are aerodynamic pods commonly mounted to the wing or fuselage of an aircraft.

In order to overcome the aforesaid and other problems of the prior art, in accordance with the present disclosure, we provide an integrated hydrogen FC electric engine system for aircraft comprising a centrifugal compressor and a turbine rotatably mounted, back-to-back on a common shaft, with the FCs arranged around an outside of the rotatably mounted centrifugal compressor and the rotatably mounted turbine.

In one embodiment, the FC is arranged so that the FC cathodes are positioned facing inwardly towards and closer to the common shaft while the FC anodes are positioned facing outwardly, i.e., facing away from the common shaft.

In accordance with one embodiment, the centrifugal compressor shares a common shaft with an exhaust turbine. Both the centrifugal compressor and the exhaust turbine have a compact length, while providing adequate airflow and pressure to the FC cathode. In order to minimize size and maximize airflow efficiencies, FCs are arranged such that their cathodes are in close proximity to the compressor outlet and the turbine inlet. Airflow from the rotatably mounted centrifugal compressor may be directed through the cathode to the turbine.

In this embodiment, an anode tail oxidizer combusts anode exhaust hydrogen with cathode exhaust air and delivers resulting exhaust to the turbine.

In another embodiment, the FC comprises a single continuous radially symmetric FC.

In yet another embodiment, a radial array of roughly rectangular FC stacks is arranged around the central shaft.

The result is an axially compact layout, which allows the length of the rotating elements to be minimized. This reduces weight associated with long shafts and multiple bearing supports of prior art integrated FC-powered electric engine system such as illustrated in FIG. 1, as above described, and also makes it possible to package our integrated hydrogen FC-powered electric engine within a conventional aircraft nacelle.

In yet another embodiment, the hydrogen FC-powered electric engine includes annular ducting configured to provide cooling air to the FCs. The annular duct may have an air inlet configured for uninterrupted axial delivery of airflow to the compressor and exhaust of spent air from the turbine via an air exhaust outlet. In such an embodiment, the annular ducting may be exposed to ram pressurization of a moving vehicle such as an aircraft or by a fan, which in a preferred embodiment is concentric with the compression-turbine (CT) shaft.

In one embodiment, when a fan is provided the fan has a larger diameter and lower rotational speed than the CT shaft. In such case, the fan axis may be connected to the CT shaft via a gearbox, preferably via planetary gearing.

In yet another embodiment, the fan is driven from its outside rim. In such embodiment, the fan need not be in contact with the CT shaft and may have its own bearings for support.

In one embodiment cooling air after passing through the FC and is warmed, and the warmed air is passed through a cooling-air turbine to recover some of the heat energy in the form of mechanical power.

In yet another embodiment, the common shaft is extended on either end to connect to electric motors, generators, and gearboxes and/or propulsion systems such as a propeller.

More particularly, in accordance with one aspect of the disclosure there is provided an integrated hydrogen FC electric engine comprising: a centrifugal compressor and a turbine rotatably mounted, back-to-back on a common shaft; and one or more FCs arranged around an outside of the rotatably mounted centrifugal compressor and the rotatably mounted turbine.

In one aspect the one or more FCs are arranged with their cathode sides closer to the common shaft.

In one aspect airflow from the rotatably mounted centrifugal compressor is directed through the cathode to the turbine.

In another aspect the rotatably mounted compressor and the rotatably mounted turbine are housed within an annular duct having an air inlet configured for uninterrupted axial delivery of airflow to the compressor and exhaust of spent air from the turbine via an air exhaust outlet.

In one aspect, one or more FCs comprise a single, continuous radially-symmetrically shaped FC.

In another aspect, one or more FCs comprise a plurality of FCs arranged in a radial array of FCs around the central shaft.

In yet another aspect, one or more FCs comprise a plurality of FCs in the form of a radial array of substantially rectangularly shaped FC stacks arranged around the central shaft.

In another aspect, the integrated hydrogen FC electric engine further comprising one or more fans for moving cooling air through the one or more FCs.

In one aspect the one or more fans are configured to be driven by the central shaft. In such aspect, one or more shafts may be configured to be driven by the central through a gearbox driven by the central shaft. In such aspect the gearbox preferably comprises planetary gears.

In another aspect, one or more fans preferably are configured to be driven from their outside rims. In such aspect, one or more fans preferably are configured to be supported on bearings or rollers in contact with the fans' outer rims.

In a further aspect, the integrated hydrogen FC electric engine is fitted into an aircraft nacelle.

In another aspect, the one or more FCs comprises a single, continuous radially-symmetrically shaped FC.

In another aspect, there is provided a hydrogen FC-powered aircraft comprising at least one hydrogen FC electric engine system as described above. In such aspect, the integrated hydrogen gas FC electric engine preferably is mounted within a wing nacelle of the aircraft.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIG. 1 is a schematic view of an integrated hydrogen FC electric engine system in accordance with the prior art;

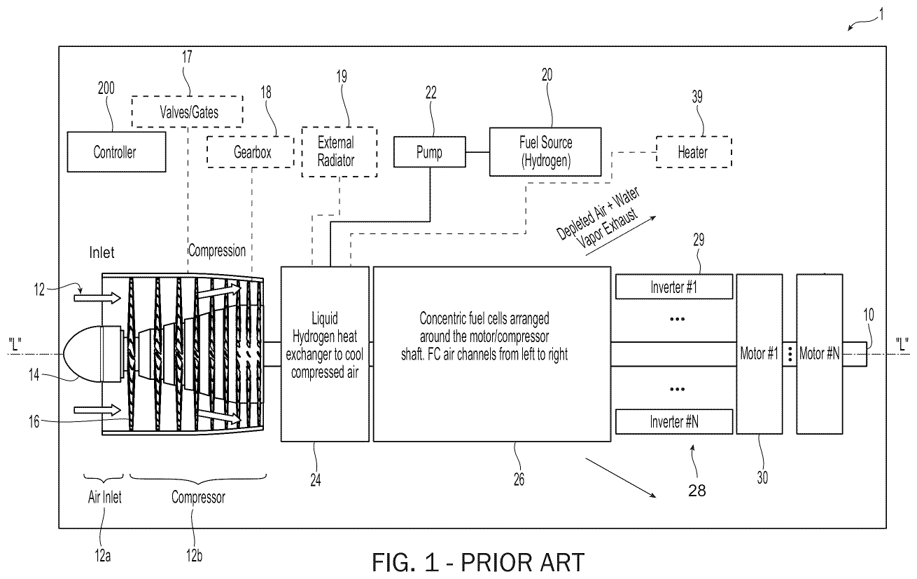

FIG. 2 is a schematic view of an integrated hydrogen FC electric engine system in accordance with an embodiment of the present disclosure;

FIG. 3A is a view taken along line 3-3 of FIG. 2;

FIG. 3B is a perspective view of an alternative embodiment of the integrated hydrogen FC electric engine systems in accordance with the present disclosure;

FIG. 3C is a cross-sectional view of an alternative embodiment of the integrated hydrogen FC electric engine system in accordance with the present disclosure;

FIG. 4A is a view, similar to FIG. 2, of yet another alternative embodiment of an integrated hydrogen FC electric engine system in accordance with the present disclosure; and

FIG. 4B is a cross-sectional view of a FC electric engine system with anode tail oxidizer, in accordance with the present disclosure;

FIG. 4C is a cross-sectional view of a FC electric engine system with gearboxes to allow various rotational velocities, in accordance with the present disclosure;

FIG. 5 is a schematic view of an aircraft including a pair of hydrogen FC electric engine systems in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

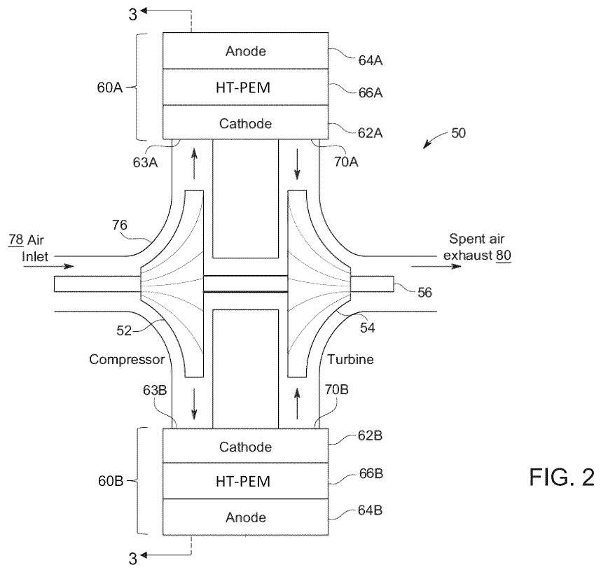

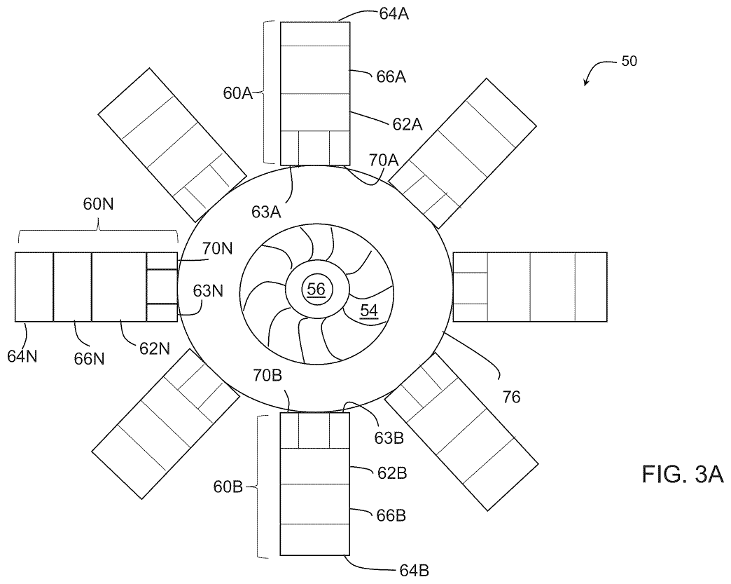

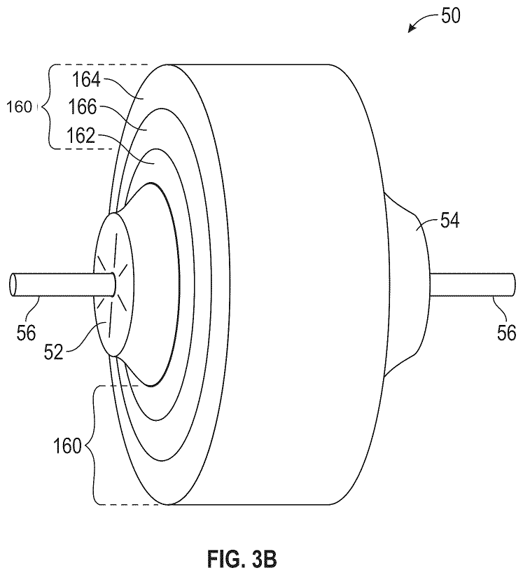

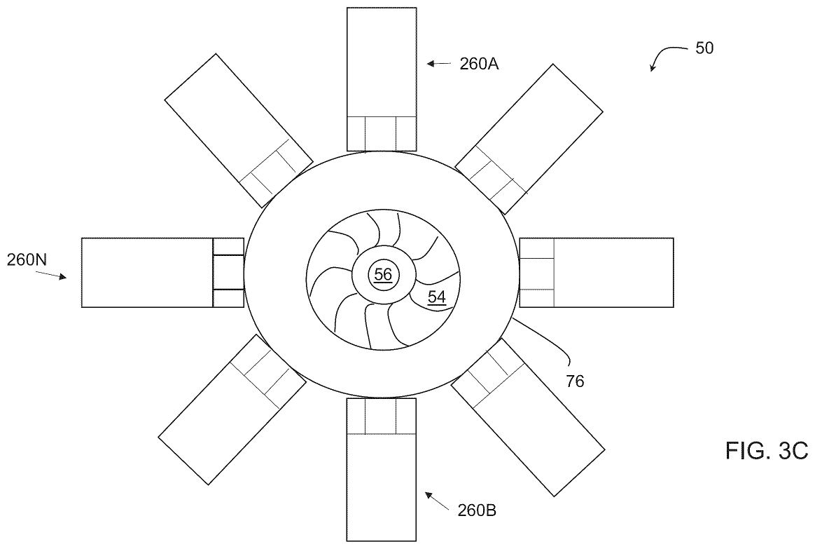

Referring to FIGS. 2 and 3A, an integrated hydrogen FC electric engine 50 in accordance with present disclosure includes a centrifugal compressor 52 and a turbine 54 rotatedly mounted on a common shaft 56. Compressor 52 and turbine 54 are mounted back-to-back on common shaft 56. A plurality of FCs 60A, 60B . . . are arranged in annular groupings around the outside of the compressor-turbine combination, with the FC cathodes 62A, 62B . . . 62N facing toward the inside, i.e., facing shaft 56 and arranged so that air flows from compressor 52 into the cathode inlets 63A, 63B . . . 63N on the cathode side of the FCs 60A, 60B . . . 60N, and anodes 64A, 64B . . . 64N facing toward the outside. An annular high temperature proton exchange membrane (HT-PEM) 66A, 66B . . . 66N is positioned between the anodes 64A, 64B . . . 64N and the cathodes 62A, 62B . . . 62N. The air introduced on the cathode side of the FCs 60A, 60B . . . 60N reacts with hydrogen (H₂) gas introduced on the anode side of the FCs 60A, 60B, . . . 60N producing electricity and a cathode reactant gas stream comprising primarily warm air and water. The cathode reactant gaseous stream is then passed via cathode outlets 70A, 70B . . . 70N through turbine 54 to extract mechanical work from the stream of warm moist air. The compressor 52 and turbine 54 assembly is housed within an annular duct 76 which includes an air inlet 78 configured for uninterrupted axial delivery of air flow to the compressor 52, and exhaust of spent air via an air exhaust outlet 80 from the turbine 54.

Referring to FIG. 3B, in an alternative embodiment, the FC is in the form of a single continuous radially-symmetric shaped FC 160 having an annular cathode 162 and annular anode 164 separated by an annular HT-PEM 166, surrounding the centrifugal compressor 52 and turbine 54. Referring to FIG. 3C, in yet another alternative embodiment, the FC is in the form of a radial array of substantially rectangularly shaped FC stacks 260A, 260B . . . 260N arranged around the central shaft 56 of turbine 54.

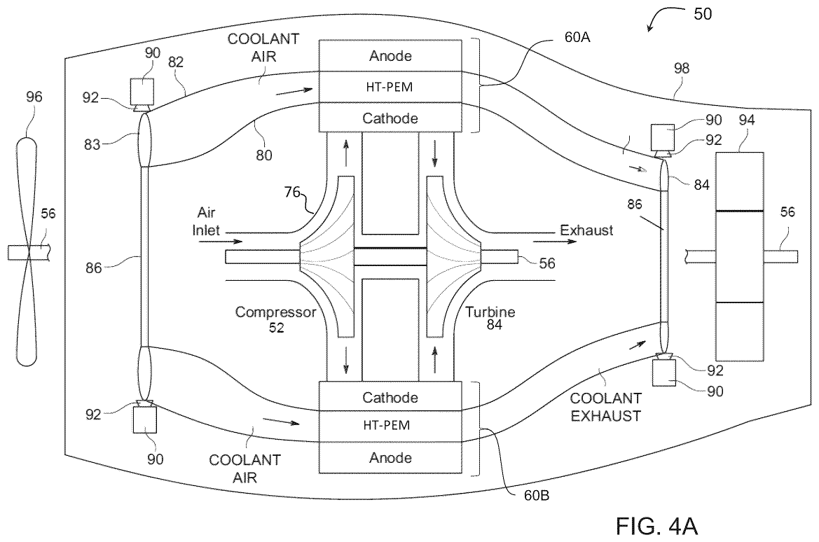

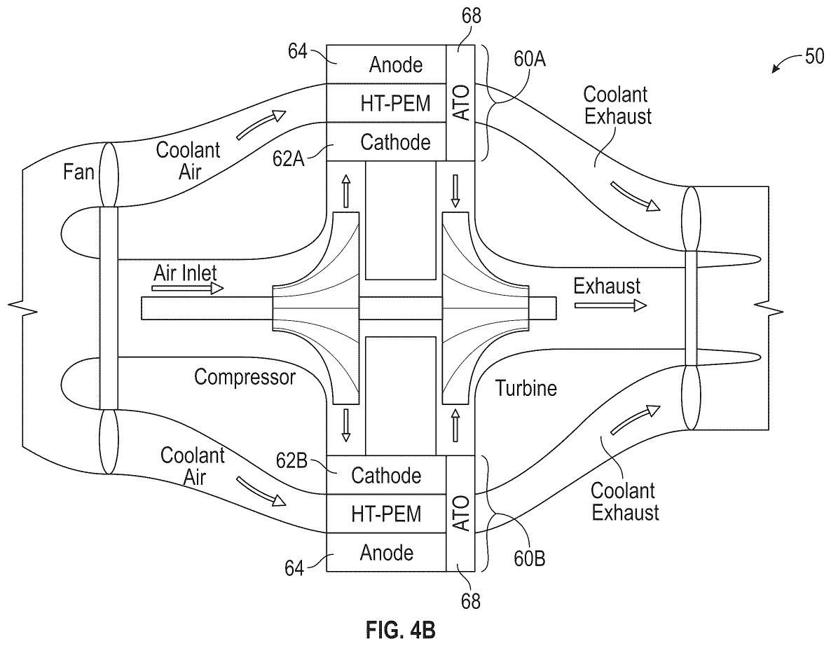

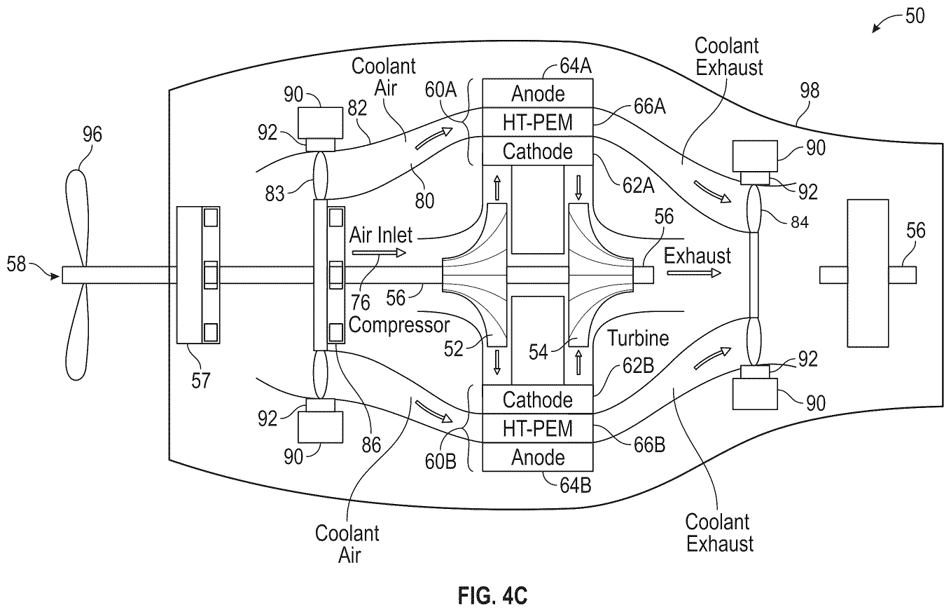

Referring to FIG. 4A, in still another embodiment the annular duct 76 is surrounded by an outer duct 82, and includes fans 83, 84 upstream and downstream of FCs 60A, 60B . . . 60N as shown in FIG. 3A, concentrically mounted on shaft 56 for moving cooling air through the FCs. In a preferred embodiment, fans 83, 84 have larger diameters and lower rotational speeds than shaft 56 and may be connected to shaft 56 via gearboxes 86, which typically are planetary gearboxes.

Alternatively, fans 83 may be driven from their outside rims via electric motors 90. In such case, fans 83 need not be in direct contact with shaft 56 but rather may be supported on bearings or rollers 92 in contact with the fans' outside rims.

After the cooling air passes through the FCs and picks up heat, it may be passed through a cooling air turbine 84 to recover some of the heat energy as mechanical work.

Shaft 56 also may be extended on either end to connect to other mechanical accessories (not shown), such as electric motors, generators and gearboxes, hydraulic pumps, etc., (not shown), to drive and/or propulsion systems such as a propeller 96, usually via a gearbox 57, as shown in FIG. 4C.

The integrated hydrogen FC electric engine system may be fitted into a conventional aircraft nacelle 98. Typically, the nacelle 98 is mounted on the wing or fuselage of an aircraft. FIG. 4B shows an anode tail oxidizer (ATO) 68 which reacts unused hydrogen with cathode exhaust before the exhaust exits through the turbine. The ATO 68 is connected so that it receives the hydrogen that is not consumed at the FC anode 64, and the ATO 68 also receives exhaust containing heated air and water from the cathode 62. The ATO 68 may comprise a flame combustion reactor or surface catalytic reactor. The resulting gaseous ATO exhaust is expelled to the turbine to recover the heat energy as mechanical energy.

FIG. 4C shows the use of a gearbox 57 to adapt the rotational velocity of the turbine and compressor section to the rotational velocity of the propeller shaft 58 and propeller 96. FIG. 4C also shows that a gearbox 86 can adapt the rotational velocity of the turbine and compressor section to the coolant inlet fan 83. Additionally, FIG. 4C shows that coolant inlet fan 83 and coolant outlet fan 84 may be powered by electric motors 90 and supported by bearings 92.

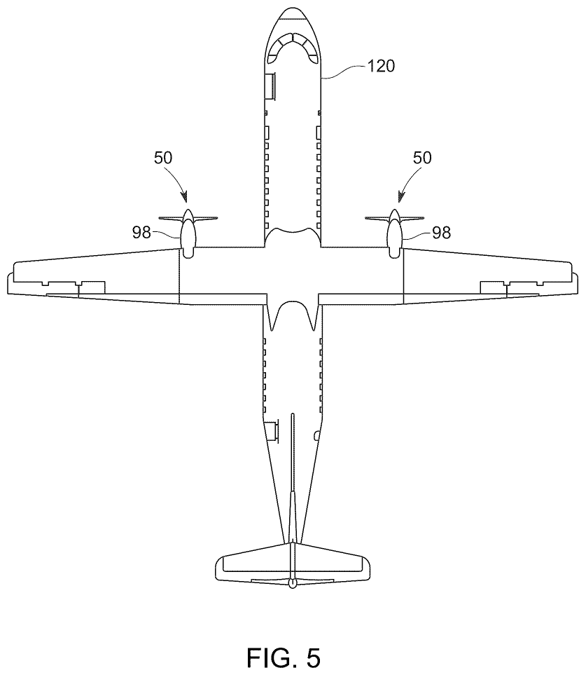

FIG. 5 illustrates an aircraft 120 including a pair of integrated hydrogen gas FC electric engine systems 50 in the nacelles 98 of the aircraft in accordance with the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

What is claimed:

1. An integrated hydrogen fuel cell (FC) electric engine comprising:
a centrifugal compressor and a turbine rotatably mounted, back-to-back on a common shaft; and
one or more FCs arranged around an outside of the rotatably mounted centrifugal compressor and the rotatably mounted turbine.

2. The integrated hydrogen FC electric engine of claim 1, wherein the one or more FCs are arranged with their cathode sides closer to the common shaft.

3. The integrated hydrogen FC electric engine of claim 2, wherein airflow from the rotatably mounted centrifugal compressor is directed through the cathode to the turbine.

4. The integrated hydrogen FC electric engine of claim 3, wherein an anode tail oxidizer combusts anode exhaust hydrogen with cathode exhaust air and delivers resulting exhaust to the turbine.

5. The integrated hydrogen FC electric engine of claim 1, wherein the rotatably mounted compressor and the rotatably mounted turbine are housed within an annular duct having an air inlet configured for uninterrupted axial delivery of airflow to the compressor and exhaust of spent air from the turbine via an air exhaust outlet.

6. The integrated hydrogen FC electric engine of claim 1, wherein the one or more FCs comprises a plurality of FCs arranged in a radial array of FCs around the central shaft.

7. The integrated hydrogen FC electric engine of claim 1, wherein the one or more FCs comprises a plurality of FCs in the form of a radial array of substantially rectangularly shaped FC stacks arranged around the central shaft.

8. The integrated hydrogen FC electric engine of claim 1, further comprising one or more fans for moving cooling air through the one or more FCs.

9. The integrated hydrogen FC electric engine of claim 8, wherein one or more fans are configured to be driven by the central shaft.

10. The integrated hydrogen FC electric engine of claim 9, wherein one or more shafts are configured to be driven by the central through a gearbox driven by the central shaft.

11. The integrated hydrogen FC electric engine of claim 10, wherein the gearbox comprises planetary gears.

12. The integrated hydrogen FC electric engine of claim 11, wherein the one or more fans are configured to be driven from their outside rims.

13. The integrated hydrogen FC electric engine of claim 12, wherein one or more fans are configured to be supported on bearings or rollers in contact with the fans' outer rims.

14. The integrated hydrogen FC electric engine of claim 1, fitted into an aircraft nacelle.

15. The integrated hydrogen FC electric engine of claim 1, wherein the one or more FCs comprises a single, continuous radially-symmetrically shaped FC.

16. A hydrogen FC-powered aircraft comprising at least one hydrogen FC electric engine system as claimed in claim 1.

17. The hydrogen FC-powered aircraft of claim 16, wherein the integrated hydrogen gas FC electric engine is mounted within the aircraft nacelle of the aircraft.
